(19) United States
(12) Patent Application Publication
(10) Pub. No.: US 2025/0020316 A1
(43) Pub. Date: Jan. 16, 2025

(54) HIGHLY WATERPROOF LAMP WITHOUT LAMP HOLDER, AND HIGHLY WATERPROOF LIGHT STRING

(71) Applicants: Guangdong Jiaduowang Lighting Tech Co., Ltd, Dongguan (CN); Dongguan Miray E-Tech Co., Ltd, DONGGUAN (CN)

(72) Inventor: Ziyang Lei, Dongguan (CN)

(21) Appl. No.: 18/898,728

(22) Filed: Sep. 27, 2024

(30) Foreign Application Priority Data
Jul. 22, 2024 (CN) 202421737431.1

(51) Int. Cl. F21V 31/00; F21K 9/235; F21S 4/10; F21V 19/00; F21V 21/08; F21V 23/00; F21V 23/06; F21Y 115/10

(52) U.S. Cl. CPC F21V 31/005; F21K 9/235; F21S 4/10; F21V 19/0025; F21V 21/08; F21V 23/002; F21V 23/06; F21Y 2115/10

(57) ABSTRACT

The present disclosure relates to the technical field of lamps and discloses a highly waterproof lamp without a lamp holder, and a highly waterproof light string. The lamp includes a lampshade, a waterproof rubber base, and a wick assembly; the waterproof rubber base is arranged on an inner side of an opening part of the lampshade; and the waterproof rubber base is provided with at least two wire guide holes.

### TECHNICAL FIELD

The present disclosure relates to the technical field of bulbs, and in particular, to a highly waterproof lamp without a lamp holder, and a highly waterproof light string.

### BACKGROUND

In a traditional outdoor decorative light string, connection between a string wire and a lamp is mainly achieved by embedding a metal copper sleeve in a plastic lamp base, and the lamp is in threaded connection with a metal threaded lamp holder of a bulb to achieve mounting of the lamp. However, in this connection mode, a large number of metal materials need to be used, causing high molding cost for the bulb. For example, the cost of a single copper sleeve is about 0.3 yuan, and the cost of the metal threaded lamp holder of the bulb is about 0.2 yuan. Meanwhile, a large amount of plastic needs to be wrapped around the copper sleeve, which further increases the cost. The high production cost of the bulb is not conducive to production and cannot meet the existing production needs. In view of this, the inventor has made a new invention.

### SUMMARY

To overcome the shortcomings in the prior art, the present disclosure aims to provide a highly waterproof lamp without a lamp holder, and a highly waterproof light string, which have the characteristic of low cost.

To achieve the above objectives, the present disclosure provides a highly waterproof lamp without a lamp holder, including a lampshade, a waterproof rubber base, and a wick assembly; the waterproof rubber base is arranged on an inner side of an opening part of the lampshade; the waterproof rubber base is provided with at least two wire guide holes; a waterproof threaded base is formed on an outer side of the opening part of the lampshade through injection molding; the waterproof threaded base seals the opening part of the lampshade; an external thread portion is provided on an outer circumferential side of the waterproof threaded base; a plugging slot is further provided in a middle part of the waterproof threaded base; the wick assembly is arranged in the lampshade; the wick assembly at least includes a first metal wire, a light source member, and a second metal wire which are electrically connected with each other in sequence; the other end of the first metal wire and the other end of the second metal wire pass through the wire guide holes, extend into the plugging slot, and form a first conductive plugging column and a second conductive plugging column. The highly waterproof lamp further comprises a branch power cable; the branch power cable is provided with an electric connection base; the branch power cable is movably sleeved with a threaded cap; the electric connection base is plugged into the plugging slot, and the electric connection base is provided with a plugging hole adapted to the conductive plugging columns; an internal thread portion is provided on an inner wall of the threaded cap; and the threaded cap is in threaded connection with the external thread portion through the internal thread portion.

Preferably, the light source member is a light-emitting diode (LED) light bar or an LED light bead.

Preferably, the plugging slot is provided with a positioning block; and the electric connection base is provided with a positioning slot adapted to the positioning block.

Preferably, each of the first metal wire and the second metal wire includes a conductive wire and a conductive column; a diameter of the conductive column is greater than a diameter of the conductive wire; and each of the first conductive plugging column and the second conductive plugging column is a part of each conductive column.

Preferably, the electric connection base includes an assembling portion and a plugging portion; the plugging portion is plugged into the plugging slot; a platform portion configured to seal an open end of the plugging slot is provided between the assembling portion and the plugging portion; and a sealing ring is further arranged above the platform portion.

Preferably, several fluorescent filaments are placed in the lampshade.

The present disclosure further provides a highly waterproof light string, including a plurality of the lamps described above, further including a main power cable, a male plug, a female socket, and a plurality of light string connectors; the male plug and the female socket are respectively arranged at two ends of the main power cable; the plurality of light string connectors are uniformly distributed in a middle part of the main power cable; and the branch power cable extends into the light string connectors and is electrically connected to the main power cable.

Preferably, the light string connectors are provided with hanging lugs for ease of hanging of the lamps.

Preferably, the highly waterproof light string further includes a hook; an clastic clamping portion is arranged at one end of the hook; and the elastic clamping portion is clamped into the hanging lugs.

Preferably, the branch power cable at least includes a first positive wire and a first negative wire; the main power cable at least includes a second positive wire and a second negative wire; the first positive wire is electrically connected to the second positive wire through butt welding; and the first negative wire is electrically connected to the second negative wire through butt welding.

Beneficial effects: Compared with the prior art, the present disclosure provides a highly waterproof lamp without a lamp holder, and a highly waterproof light string. The present disclosure has the following advantages: 1. The mounting mode for the lamp is improved. Electric connection between the lamp and a power cable is achieved through socket plugging, without a metal lamp holder and a metal copper sleeve, which can greatly reduce the manufacturing cost of a light string and meet the existing production need. 2. The opening part of the lampshade is formed into a waterproof threaded base through injection molding and is used in conjunction with the waterproof rubber base to achieve secondary sealing and waterproofing of the lamp, thereby completely isolating external moisture from the bulb and effectively prolonging the service life of the light string. 3. After the lamp is plugged and assembled, the exterior of the lamp is fixed through a threaded cap, so that the connection is firm. Furthermore, the lamp is removable for replacement, so that the flexibility of the light string is improved.

### BRIEF DESCRIPTION OF THE DRAWINGS

FIG. 1 is a schematic diagram of an entire structure of the present disclosure.

FIG. 2 is a schematic structural diagram of an embodiment of an LED light bead according to the present disclosure.

FIG. 3 is a schematic structural diagram of a waterproof threaded base and an electric connection base according to the present disclosure.

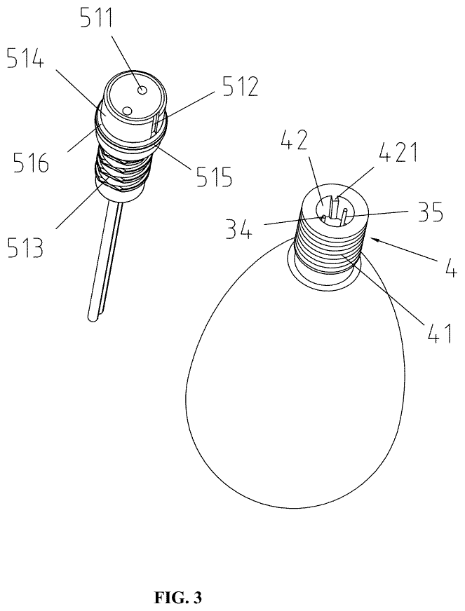

FIG. 4 is a schematic structural diagram of a wick assembly according to the present disclosure.

FIG. 5 is a schematic structural diagram of a waterproof light string of the present disclosure.

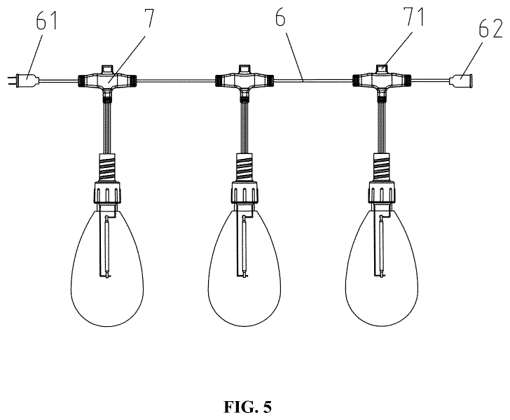

FIG. 6 is a schematic partially enlarged diagram of a connection between a main power cable and a branch power cable according to the present disclosure.

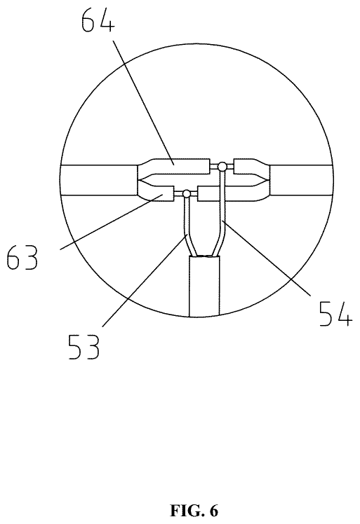

FIG. 7 is a schematic structural diagram of an embodiment of a connector of a light string according to the present disclosure.

FIG. 8 is a schematic structural diagram of a hook according to the present disclosure.

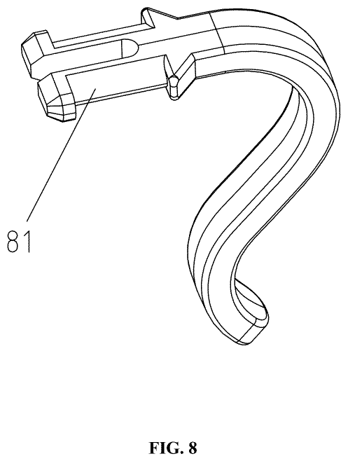

### REFERENCE NUMERALS INCLUDE

1: lampshade; 11: fluorescent filament; 2: waterproof rubber base; 21: wire guide hole; 3: wick assembly; 31: first metal wire; 311: conductive wire; 312: conductive column; 32: light source member; 33: second metal wire; 34: first conductive plugging column; 35: second conductive plugging column; 4: waterproof threaded base; 41: external thread portion; 42: plugging slot; 421: positioning block; 5: branch power cable; 51: electric connection base; 511: plugging hole position; 512: positioning slot; 513: assembling portion; 514: plugging portion; 515: platform portion; 516: sealing ring; 52: threaded cap; 53: first positive wire; 54: first negative wire; 6: main power cable; 61: male plug; 62: female socket; 63: second positive wire; 64: second negative wire; 7: light string connector; 71: hanging lug; 8: hook; 81: elastic clamping portion; and 9: resistor.

### DETAILED DESCRIPTION OF THE EMBODIMENTS

The present disclosure will be explained below in conjunction with the accompanying drawings 1 to 8.

The present disclosure provides a highly waterproof lamp without a lamp holder, including a lampshade 1, a waterproof rubber base 2, and a wick assembly 3. The waterproof rubber base 2 is arranged on an inner side of an opening part of the lampshade 1; the waterproof rubber base 2 is provided with at least two wire guide holes 21; a waterproof threaded base 4 is formed on an outer side of the opening part of the lampshade 1 through injection molding; the waterproof threaded base 4 seals the opening part of the lampshade 1; an external thread portion 41 is provided on an outer circumferential side of the waterproof threaded base 4; a plugging slot 42 is further provided in a middle part of the waterproof threaded base 4; the wick assembly 3 is arranged in the lampshade 1; the wick assembly 3 at least includes a first metal wire 31, a light source member 32, and a second metal wire 33 which are electrically connected with each other in sequence; the other end of the first metal wire 31 and the other end of the second metal wire 33 pass through the wire guide holes 21, extend into the plugging slot 42, and form a first conductive plugging column 34 and a second conductive plugging column 35. The highly waterproof lamp further includes a branch power cable 5; the branch power cable 5 is provided with an electric connection base 51; the branch power cable 5 is movably sleeved with a threaded cap 52; the electric connection base 51 is plugged into the plugging slot 42, and the electric connection base 51 is provided with a plugging hole 511 adapted to the conductive plugging columns; an internal thread portion is provided on an inner wall of the threaded cap 52; and the threaded cap 52 is in threaded connection with the waterproof threaded base 4 through the internal thread portion.

The present disclosure improves the connection mode for the lamp and the power cable. The mode for electrically connecting the metal threaded lamp holder to the metal copper sleeve of the traditional lamp is improved as plugging assembling between the lamp and the power cable. This assembling mode saves a large number of metal raw materials and greatly reduces the manufacturing cost of the light string. The original metal material cost of about 0.6 yuan is reduce to about 0.06 yuan after the improvement. Meanwhile, a lamp base with a large volume does not need to be coated and formed, so that the cost for plastic materials is also reduced. Secondly, in this technical solution, the waterproof rubber base 2 improves the waterproof performance of a bulb, and the waterproof threaded base 4 is formed on the outer side of the opening part of the lampshade 1 through injection molding, so that secondary waterproofing of the lamp is achieved. After the waterproof threaded base 4 is formed, the opening part of the lampshade 1 is thoroughly sealed, to achieve absolute sealing of the lamp. On the other hand, after the lamp is electrically plugged to the branch power cable 5, threaded fixing and assembling are achieved through the external threaded cap 52, so that the assembling is firm and convenient. Furthermore, the lamp is removable and replaceable, so that the flexibility of the light string is higher.

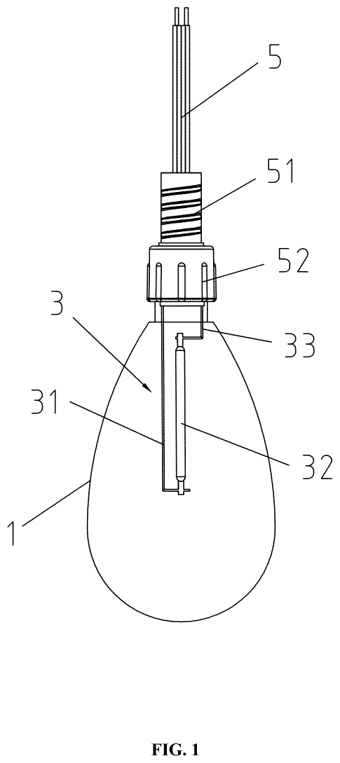

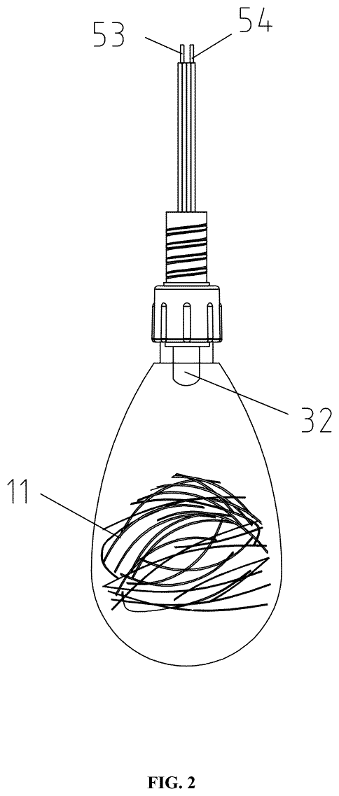

As shown in FIG. 1 and FIG. 2, the light source member 32 of this technical solution can be an LED light bar or an LED light bead. During production, a light-emitting element can be randomly selected according to a use requirement. The LED light bead can be a controllable seven-color light bead.

To improve the plugging efficiency of the waterproof threaded base 4 and the branch power cable 5, the plugging slot 42 is provided with a positioning block 421, and the electric connection base 51 is provided with a positioning slot 512 adapted to the positioning block 421. To assemble and form the lamp, the positioning slot 512 of the electric connection base 51 is aligned with the positioning block 421 for assembling. Whether it is manual assembling or automated assembling, the assembling efficiency can be significantly improved.

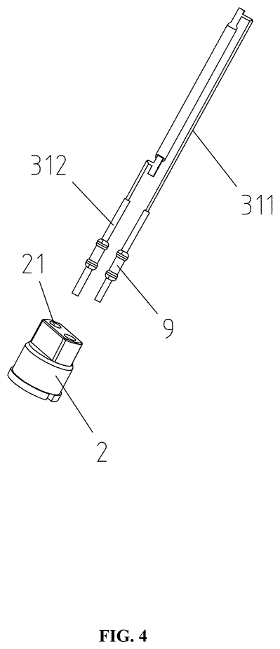

As a preference, each of the first metal wire 31 and the second metal wire 33 is composed of a conductive wire 311 and a conductive column 312. A diameter of the conductive column 312 is greater than a diameter of the conductive wire 311. The conductive wire 311 is electrically connected to the light source member 32. The conductive column 312 passes through the waterproof rubber base 2 and extends into the plugging slot 42. A first conductive plugging column 34 with high strength and a second conductive plugging column 35 with high strength are formed at tail ends of the conductive columns 312 to achieve mutual plugging into the electric connection base 51. This structure can ensure that the first metal wire 31 and the second metal wire 33 have sufficient strength to be plugged into the electric connection base 51, further save raw materials for the metal wires, and further reduce the manufacturing cost. As shown in FIG. 4, the first metal wire and the second metal wire are further provided with heat dissipation resistors 9.

In an embodiment, the electric connection base 51 includes an assembling portion 513 and a plugging portion 514; the plugging portion 514 is plugged into the plugging slot 42; and a platform portion 515 configured to seal an open end of the plugging slot 42 is provided between the assembling portion 513 and the plugging portion 514 to prevent external moisture from entering the plugging slot 42.

To further improve the waterproof performance, a sealing ring 516 is further arranged above the platform portion 515. When the electric connection base 51 is plugged into the plugging slot 42, the sealing ring 516 is pressed to deform, to further seal a connection gap between the electric connection base 51 and the waterproof threaded base 4.

As a preference, several fluorescent filaments 11 are placed in the lampshade 1. The fluorescent filaments 11 are varicoloured. When the light source member 32 emits light, the fluorescent filaments 11 can reflect some of the light in different directions, to increase changes of the light, thereby enhancing the visual experience of a user and optimizing the decorative effect of the lamp.

The present disclosure further includes a highly waterproof light string, including a plurality of the lamps described above, further including a main power cable 6, a male plug 61, a female socket 62, and a plurality of light string connectors 7. The male plug 61 and the female socket 62 are respectively arranged at two ends of the main power cable 6. This facilitates electric connection between the light string and an external power supply or electric connection between one light string and another light string. The plurality of light string connectors 7 are uniformly distributed in a middle part of the main power cable 6; and the branch power cable 5 extends into the light string connectors 7 and is electrically connected to the main power cable 6. The light string of the present disclosure is mainly used in outdoor party decorations and has all the advantages of low cost, high waterproof performance, and the like of the above-mentioned lamp.

As a preference, the light string connectors 7 are provided with hanging lugs 71 that facilitate the hanging of the light string outdoors.

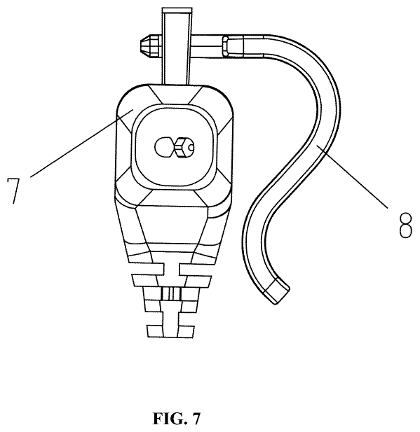

To enlarge the range of application of the light string, the light string further includes a hook 8. An elastic clamping portion 81 is arranged at one end of the hook 8. During use, the elastic clamping portion 81 can be clamped into the hanging lugs 71, to form a light string hanging structure as shown in FIG. 7. After the hanging lugs 71 of the light string connectors 7 are used in conjunction with the hook 8, another form of hanging structure is achieved, so that the light string can be suitable for being used in more outdoor scenes has a wider range of application.

As a preference, the branch power cable 5 at least includes a first positive wire 53 and a first negative wire 54; the main power cable 6 at least includes a second positive wire 63 and a second negative wire 64; the first positive wire 53 is electrically connected to the second positive wire 63 through butt welding; and the first negative wire 54 is electrically connected to the second negative wire 64 through butt welding. Compared with a traditional method for electric connection between a light string cable and a lamp by wrapping a copper terminal around electrode wires, the existing method for electrically connecting the electrode wires to the light string cable through butt welding can further ensure that the electrode wires are firmly connected to the lamp either during second injection molding of the light string connectors 7 or during outdoor use at ordinary times, and poor contact of the lamp can be effectively prevented.

The above content only describes preferred embodiments of the present disclosure. A person of ordinary skill in the art can make changes to specific implementations and the application scope according to the idea of the present disclosure. The content of this specification should not be understood as a limitation on the present disclosure.

What is claimed is:

1. A highly waterproof lamp without a lamp holder, comprising a lampshade (1), a waterproof rubber base (2), and a wick assembly (3), wherein the waterproof rubber base (2) is arranged on an inner side of an opening part of the lampshade (1); the waterproof rubber base (2) is provided with at least two wire guide holes (21); a waterproof threaded base (4) is formed on an outer side of the opening part of the lampshade (1) through injection molding; the waterproof threaded base (4) seals the opening part of the lampshade (1); an external thread portion (41) is provided on an outer circumferential side of the waterproof threaded base (4); a plugging slot (42) is further provided in a middle part of the waterproof threaded base (4); the wick assembly (3) is arranged in the lampshade (1); the wick assembly (3) at least comprises a first metal wire (31), a light source member (32), and a second metal wire (33) which are electrically connected with each other in sequence; the other end of the first metal wire (31) and the other end of the second metal wire (33) pass through the wire guide holes (21), extend into the plugging slot (42), and form a first conductive plugging column (34) and a second conductive plugging column (35);
the highly waterproof lamp further comprises a branch power cable (5); the branch power cable (5) is provided with an electric connection base (51); the branch power cable (5) is movably sleeved with a threaded cap (52); the electric connection base (51) is plugged into the plugging slot (42), and the electric connection base (51) is provided with a plugging hole (511) adapted to the conductive plugging columns; an internal thread portion is provided on an inner wall of the threaded cap (52); and the threaded cap (52) is in threaded connection with the external thread portion (41) through the internal thread portion.

2. The highly waterproof lamp without the lamp holder according to claim 1, wherein the light source member (32) is a light-emitting diode (LED) light bar or an LED light bead.

3. The highly waterproof lamp without the lamp holder according to claim 1, wherein the plugging slot (42) is provided with a positioning block (421); and the electric connection base (51) is provided with a positioning slot (512) adapted to the positioning block (421).

4. The highly waterproof lamp without the lamp holder according to claim 1, wherein each of the first metal wire (31) and the second metal wire (33) comprises a conductive wire (311) and a conductive column (312); a diameter of the conductive column (312) is greater than a diameter of the conductive wire (311); and each of the first conductive plugging column (34) and the second conductive plugging column (35) is a part of each conductive column (312).

5. The highly waterproof lamp without the lamp holder according to claim 1, wherein the electric connection base (51) comprises an assembling portion (513) and a plugging portion (514); the plugging portion (514) is plugged into the plugging slot (42); a platform portion (515) configured to seal an open end of the plugging slot (42) is provided between the assembling portion (513) and the plugging portion (514); and a sealing ring (516) is further arranged above the platform portion (515).

6. The highly waterproof lamp without the lamp holder according to claim 1, wherein several fluorescent filaments (11) are placed in the lampshade (1).

7. A highly waterproof light string, comprising a plurality of lamps according to any one of claims 1 to 6, further comprising a main power cable (6), a male plug (61), a female socket (62), and a plurality of light string connectors (7), wherein the male plug (61) and the female socket (62) are respectively arranged at two ends of the main power cable (6); the plurality of light string connectors (7) are uniformly distributed in a middle part of the main power cable (6); and the branch power cable (5) extends into the light string connectors (7) and is electrically connected to the main power cable (6).

8. The highly waterproof light string according to claim 7, wherein the light string connectors (7) are provided with hanging lugs (71) for ease of hanging of the lamps.

9. The highly waterproof light string according to claim 8, further comprising a hook (8), wherein an elastic clamping portion (81) is arranged at one end of the hook (8); and the elastic clamping portion (81) is clamped into the hanging lugs (71).

10. The highly waterproof light string according to claim 7, wherein the branch power cable (5) at least comprises a first positive wire (53) and a first negative wire (54); the main power cable (6) at least comprises a second positive wire (63) and a second negative wire (64); the first positive wire (53) is electrically connected to the second positive wire (63) through butt welding; and the first negative wire (54) is electrically connected to the second negative wire (64) through butt welding.
